(19) United States
(12) Patent Application Publication
(10) Pub. No.: US 2025/0249770 A1
(43) Pub. Date: Aug. 7, 2025

(54) INDUCTION CHARGING UNIT AND ENERGY TRANSFER SYSTEM WITH SAME

(71) Applicant: MAHLE International GmbH, Stuttgart (DE)

(72) Inventors: Stefan Hirsch, Stuttgart (DE); Jan Pfaffenberger, Stuttgart (DE)

(21) Appl. No.: 18/854,518

(22) PCT Filed: Mar. 28, 2023
(86) PCT No.: PCT/EP2023/057973

§ 371 Date: Oct. 4, 2024

(30) Foreign Application Priority Data
Apr. 7, 2022 (DE) 10 2022 203 505.4

(51) Int. Cl. B60L 53/302; B60L 53/12; H02J 50/00

(52) U.S. Cl. CPC B60L 53/302; B60L 53/12; H02J 50/005

(57) ABSTRACT

An induction charging unit for an energy transfer system may include a cooling device, at least one electrical power component, and a clamping device. The cooling device may define a mounting face and may be configured to dissipate heat energy. The at least one electrical power component may be clamped to the mounting face of the cooling device via the clamping device.

### CROSS-REFERENCE TO RELATED APPLICATIONS

This application claims priority to International Patent Application No. PCT/EP2023/057973, filed on Mar. 28, 2023, and German Patent Application No. DE 10 2022 203 505.4, filed on Apr. 7, 2022, the contents of both of which are hereby incorporated by reference in their entirety.

### TECHNICAL FIELD

The invention relates to an induction charging unit for an energy transfer system. The invention relates in particular to an energy transmission system for inductively charging a battery-powered electric vehicle with electrical energy, comprising an induction charging unit of this kind.

### BACKGROUND

To inductively charge a battery-powered electric vehicle with electrical energy, an energy transmission system is usually used that comprises an induction charging unit arranged on the ground, also known in practice as a ground assembly (GA), and a counter-induction charging unit arranged on the vehicle. The induction charging unit and the counter-induction charging unit are designed to transfer energy without contact using magnetic coupling. Due to local flux density hot spots and hysteresis losses, electromagnetic power components arranged in the induction charging unit must be cooled, for example, the heat to be dissipated is in the range of 0.1% to 5% of the electrical power transmitted between the induction charging unit and the counter-induction charging unit. However, in the case of known induction charging units, the electrical power components are insufficiently thermally coupled to a cooling device of the induction charging units, so that optimal cooling cannot be achieved. In particular, their contact pressure on the cooling device cannot be released or can only be installed or uninstalled with difficulty, which is particularly disadvantageous in the prototype phase.

The object of the invention is therefore to provide an improved or at least a different embodiment of an induction charging unit for an energy transfer system. In particular, it should be cost-effective to produce, as compact as possible, and should realize an optimal thermal coupling of electrical power components with a cooling device for the induction charging unit. Furthermore, it should in particular enable the connection of different types of electrical power components, such as transistors, diodes, and MOSFETs.

### SUMMARY

In the present invention, this task is solved in particular by the subject matter of the independent claim(s). Advantageous embodiments are the subject matter of the dependent claim(s).

The basic idea of the invention is that the performance of the induction charging unit can be improved by means of a cooling device of the induction charging unit, based on the optimal thermal coupling of the electrical power components of the induction charging unit that heat up during operation of the induction charging unit or the energy transfer system due to their function.

Accordingly, an induction charging unit for a power transfer system is proposed, which is equipped with a cooling device that defines a mounting face and is designed to dissipate heat energy, at least one electrical power component, and a clamping device. It is essential that at least one electrical power component is clamped to the mounting face of the cooling device using the clamping device. As a result, the at least one electrical power component is clamped or pressed onto the cooling device, whereby an in particular gap-free, optimal thermal coupling of the at least one electrical power component with the cooling device is realized. This has the advantage that a relatively large flow of thermal energy can be transferred from the at least one electrical power component to the cooling device, for example by heat conduction, and dissipated by means of the same. This means that at least one electrical power component can be excellently cooled, so that a power transmission system equipped with the induction charging unit according to the invention can, for example, transmit a relatively high electrical power, i.e., between its induction charging unit and its counter-induction charging unit.

The cooling device can be implemented, for example, by a cooling plate. For example, at least one electrical power component can be pressed or clamped directly, i.e., in direct contact, or indirectly, i.e., in indirect contact, against the cooling device.

It is useful if the induction charging unit has a printed circuit board that is located opposite the cooling device in the direction of a vertical axis perpendicular to the mounting face and optionally aligned parallel to the mounting face. In this case, at least one electrical power component can be positioned in the direction of the vertical axis between the printed circuit board and the cooling device and arranged on the printed circuit board. The clamping device usefully grips through an opening in the printed circuit board. This indicates a preferred embodiment in which the clamping device reaches through an opening arranged on the printed circuit board. This has the advantage that the clamping device does not have to be positioned between the printed circuit board and the cooling device, but merely engages through it to clamp the at least one electrical power component onto the cooling device. This allows the printed circuit board and the cooling device to be positioned relatively close to each other, wherein heat energy can be optimally transferred from the at least one electrical power component and, if necessary, also from the printed circuit board to the cooling device and dissipated by the same. The circuit board is, appropriately enough, a printed circuit board, a PCB (Printed Circuit Board), with electrical conductors. At least one electrical power component, for example, is electrically connected to these electrical conductor tracks and/or fixed to a printed circuit board body by soldering, for example. Furthermore, it may be stipulated that the clamping device is arranged, for example, at least in sections or essentially, on a side of the printed circuit board facing away from the cooling device.

In addition, it may be expedient to provide that the said opening completely penetrates the printed circuit board in the direction of the vertical axis. Furthermore, the opening and the at least one electrical power component can be on the same alignment line, which is optionally parallel to the vertical axis. The said opening can thereby be situated directly above the at least one electrical power component, as it were, whereby the clamping device can interact in a clamping manner with the at least one electrical power component particularly easily.

It is also useful if the clamping device is implemented by at least one spring clamp or at least one spring clamp device. Preferred embodiments for the clamping device are thus indicated, wherein, according to the first variant, the at least one spring clamp clamps the at least one electrical power component directly to the cooling device without additional components. It is useful if two or more such spring clamps can be assigned to the at least one electrical power component. Furthermore, at least one electrical power component can be individually clamped to the cooling device by means of the at least one spring clamp. Furthermore, it is expediently envisaged that the clamping device, which is realized by at least one spring clamp device, clamps the at least one electrical power component to the cooling device. In this case, more than one spring clamp device can be assigned to the at least one electrical power component if necessary. The realization of the clamping device by means of at least one spring clamp device has the advantage that the at least one electrical power component is optimally clamped to the cooling device. For example, a spring force of the at least one spring clamp or the at least one spring clamp device can be selected or set so that the at least one electrical power component is clamped to the cooling device according to a predetermined or specifiable contact pressure.

It is useful for the at least one spring clamp or the at least one spring clamp device to reach through the said opening in the printed circuit board, at least in sections, in order to clamp the at least one electrical power component to the cooling device. In this case, it can be advantageous if the at least one spring clamp or the at least one spring clamp device acts exclusively on the at least one electrical power component and not on the printed circuit board, so that the printed circuit board is not subjected to spring force. This can reduce the mechanical stress on the printed circuit board.

Furthermore, it can be expedient to provide that the at least one spring clamp device has a base body that is immobile in relation to the cooling device, a clamping element that defines a clamping element center axis in its main direction of expansion, and an adjusting spring arranged on the clamping element.

In this case, the adjusting spring can clamp the clamping element axially with respect to the clamping element center axis onto the at least one electrical power component, so that the at least one electrical power component is clamped onto the mounting face of the cooling device by means of the clamping element. Furthermore, the adjusting spring can be arranged, for example, completely or at least in sections, on a side of the printed circuit board facing away from the cooling device. Furthermore, the clamping element can be mounted on the base body so that it can be adjusted longitudinally in the direction of the clamping element center axis. It is also possible that the clamping element center axis is aligned parallel to a vertical axis that is perpendicular to the mounting face. Furthermore, the clamping element can reach through the aforementioned opening in the printed circuit board. This describes an embodiment for a spring clamp device that can be used to clamp the at least one electrical power component to the mounting face of the cooling device. The components of the spring clamp device in question are relatively inexpensive and, for example, available in large quantities in stores, so that an induction charging unit equipped with the said spring clamp device can be manufactured relatively inexpensively.

The clamping element can be made of an electrically non-conductive material or coated with such an electrically non-conductive material. Furthermore, it may be useful if the clamping element and/or the opening of the printed circuit board for the clamping element are designed according to the Poka-Yoke principle, in order to be able to install the at least one electrical power component and/or the clamping element in a way that prevents mix-ups.

It is also useful if the clamping element and/or the opening of the printed circuit board for the clamping element are shaped in such a way that the clamping element and, if applicable, the at least one electrical power component can be pre-assembled in a loss-proof manner by means of soldering to the induction charging unit or the printed circuit board before its electrical connection to the conductor tracks of the printed circuit board. This can simplify installation. It is useful to have releasable, form-fitting connections, for example latching lugs arranged on the clamping element, by means of which the clamping element can be temporarily clamped to the printed circuit board, or additional components such as clips or snap rings, by means of which the clamping element can be temporarily clamped to the printed circuit board.

In particular, it may also be provided that the adjusting spring is realized by a pressure spring which is supported on the base body and the clamping element and is guided on the clamping element. Alternatively, it may be provided that the adjusting spring is realized by a leaf spring that is integrally designed with the base body. This means that two versions are given for adjusting springs, wherein pressure springs, for example, can be procured cost-effectively and in large quantities, and leaf springs that are integral with the base body can, in particular, reduce the effort required to install a spring clamp device.

It is also useful if the clamping element is connected to the at least one electrical power component, in particular in a form-fitting and/or force-fitting and/or material-fitting manner, for example by gluing. For example, it is possible to use a thermally conductive adhesive material that is applied in the direction of the vertical axis with a material thickness in the range of 5 μm to 150 μm and/or has a thermal conductivity in the range of 0.2 W/mK to 50 W/mK.

In this case, it is useful if the at least one spring clamp device also has a holding device made of tie rods fixed to the cooling device, by means of which the base body can be or is releasably connected to the cooling device in a form-fitting and/or force-fitting manner. The tie rods can have form-fitting contours, for example latching lugs, by means of which the base body can be fixed to a respective tie rod in a releasable or non-releasable manner, in a form-fitting and/or force-fitting manner. The said base body can also be releasably fixed to a respective tie rod in a form-fitting and/or force-fitting manner by means of fastening elements such as fastening screws and/or fastening nuts. Furthermore, the tie rods can be fixed to the cooling device in a material-fitting manner, for example by soldering or welding. In doing so, they conveniently reach through a tie rod opening specially designed for them on the said printed circuit board. Alternatively, the tie rods can be used around the printed circuit board, i.e., in particular around an outer edge of the printed circuit board, so that the printed circuit board does not have to have any openings for the tie rods. In a functional embodiment, it may be provided that at least one tie rod of the holding device stiffens the cooling device, in particular at points where at least one electrical power component is connected to the cooling device.

In a further, more functional embodiment, the base body can be realized by a flat plate or a housing cover, wherein the flat plate or the housing cover is functionally arranged on a side of the printed circuit board facing away from the cooling device.

Furthermore, it may be useful to arrange a coupling layer between the mounting face and a flat component face defined by the at least one electrical power component in the direction of an upright vertical axis perpendicular to the mounting face of the cooling device, in particular in a sandwich-like manner between the mounting face and the component face.

The coupling layer can be contacted with at least one electrical power component and/or the cooling device. The said coupling layer can be fixed to the component face of the at least one electrical power component. In this case, for example, material fitting is preferred, in particular by soldering with a suitable solder material and/or a solder coating applied to the coupling layer. This allows the coupling layer to be bonded in a material-fitting manner to the at least one electrical power component. Furthermore, the coupling layer can be connected to the mounting face by means of a contact and is releasable. The coupling layer is advantageously made of a ceramic material, wherein it optionally has a material thickness in the range of 0.2 mm to 2 mm and/or a thermal conductivity in the range of 0.2 W/mK to 50 W/mK and/or an electrical breakdown strength in the range of greater than and/or equal to 500 V DC in the direction of the vertical axis. Alternatively, the coupling layer can be realized from a composite material, for example by a plastic-based heat conducting film or by a plastic-based heat conducting pad or by a graphite film with an electrical insulating layer of plastic, and in the direction of the vertical axis a material thickness in the range of 0.05 mm to 1 mm and/or a thermal conductivity, for example perpendicular to the material thickness, in the range from 0.1 W/mK to 5 W/mK and/or an electrical breakdown strength in the range greater than and/or equal to 200 V DC. The interface can be used to optimally couple at least one electrical power component thermally and/or mechanically to the mounting face of the cooling device with the aid of the coupling layer.

It is useful if a fixing layer is arranged in the direction of the vertical axis between the coupling layer and the component face of the at least one electrical power component for connecting or contacting the coupling layer to the at least one electrical power component, wherein the fixing layer can in particular be sandwiched between the coupling layer and the component face. The fixing layer has a dual function: It should realize the best possible heat conduction to the coupling layer and sufficiently good electrical insulation between the at least one electrical power component and the printed circuit board or the cooling device. In this context, it may be envisaged that the fixing layer is realized in the direction of the vertical axis in a thin manner with respect to the coupling layer and expediently made of a thermally conductive adhesive material, for example an adhesive layer. It may also be provided that the fixing layer, in particular as an adhesive layer, has a material thickness in the range of 5 μm to 150 μm and/or a thermal conductivity in the range of 0.2 W/mK to 50 W/mK in the direction of the vertical axis. The fixing layer allows the coupling layer to be fixed to the component face of the at least one electrical power component. Furthermore, the fixing layer can realize an optimal thermal and/or mechanical coupling of the coupling layer with the at least one electrical power component. In this context, the specified thermal conductivity of the fixing layer can have a particularly positive influence on the transfer of heat energy from the at least one electrical power component to the coupling layer.

Furthermore, it is possible that the clamping element is connected to the at least one electrical power component or the coupling layer in a form-fitting manner. This can be realized in particular by means of a clip or a latching lug. This has the advantage that the clamping element does not have to be connected in a material-fitting manner to the at least one electrical power component or to the coupling element, so that, for example, the aforementioned soldering process for connecting the coupling layer in a material-fitting manner to the at least one electrical power component can be omitted.

It is also useful if the clamping element electrically insulates the at least one electrical power component, in particular from the said printed circuit board and from the cooler device. To provide electrical insulation, the at least one electrical power component mainly uses a coupling layer, which is explained below. In particular, a fixing layer, which is explained below, can be used to ensure that the connection between the clamping element or the holder and the coupling layer is uninterrupted. For example, the clamping element can be designed to achieve electrical insulation with a dielectric strength of greater than or equal to 200 V DC, in particular to the said printed circuit board. To this end, it is expedient for the clamping element to enclose at least a section of the at least one electrical power component. This can prevent a short circuit that could endanger at least one electrical power component and thus improve the operational safety of the induction charging unit.

Furthermore, it may be useful to arrange a contact layer between the coupling layer and the mounting face of the cooling device in the direction of the vertical axis, which is designed to contact the coupling layer with the cooling device. The contact layer is sandwiched between the coupling layer and the mounting face. Furthermore, the contact layer can be realized by an oil film made of heat transfer oil and, again, it is advisable that it is non-adhesive and/or non-hardening. On the basis of the contact layer, on the one hand an optimal thermal and/or mechanical coupling of the coupling layer and/or of the at least one electrical power component with the cooling device, and on the other hand a relatively simple deinstallation of the at least one electrical power component from the cooling device can be realized. The contact layer can be designed with suitable thermal conductivity for this purpose.

It is also useful if the mounting face of the cooling device, in particular where the coupling layer or the at least one electrical power component can be connected, is provided with a surface quality that is improved compared to other surface qualities of the cooling device. This can be achieved, for example, by treating the mounting face of the cooling device using special production methods such as embossing, milling, grinding, polishing, brushing, and cleaning. In particular, surface characteristics of the mounting face of the cooling device, such as flatness and/or surface roughness, may be optimized.

Another basic principle of the invention is for the purpose of indicating an energy transfer system with an induction charging unit according to the above description. A corresponding energy transfer system for inductively charging a battery-powered electric vehicle with electrical energy therefore has an induction charging unit as described above and a counter-induction charging unit arranged on the vehicle side, wherein the induction charging unit and the counter-induction charging unit are set up to transfer energy without contact by means of magnetic coupling. An advantageous power transmission system with an induction charging unit as defined in the preceding description is capable of transmitting a relatively high electrical power due to the improved cooling capability of the induction charging unit.

The clamping device can be used, for example, in the housing of an electrical device.

To summarize, it remains to be said: The present invention relates, in a functional sense, to an induction charging unit for a power transmission system, with a cooling device that defines a mounting face and is designed to dissipate heat energy, with at least one electrical power component and with a clamping device. It is essential that at least one electrical power component is clamped to the mounting face of the cooling device using the clamping device. The invention relates in particular to an energy transmission system for inductively charging a battery-powered electric vehicle with electrical energy, comprising an induction charging unit of this kind.

Other important features and advantages of the invention can be seen from the dependent claims, from the drawings, and from the associated description of the figure based on the drawings.

It is understood that the above-mentioned features and those yet to be explained below can be used not only in the combination indicated in each case, but also in other combinations or on their own, without deviating from the scope of the present invention.

Preferred embodiments of the invention are shown in the drawings and are explained in more detail in the following description, wherein identical reference signs refer to identical or similar or functionally identical components.

### BRIEF DESCRIPTION OF THE DRAWINGS

The following is shown in the images below:

FIGS. 1 through 9 each show an induction charging unit in a symbolic sectional view according to a preferred embodiment.

### DETAILED DESCRIPTION

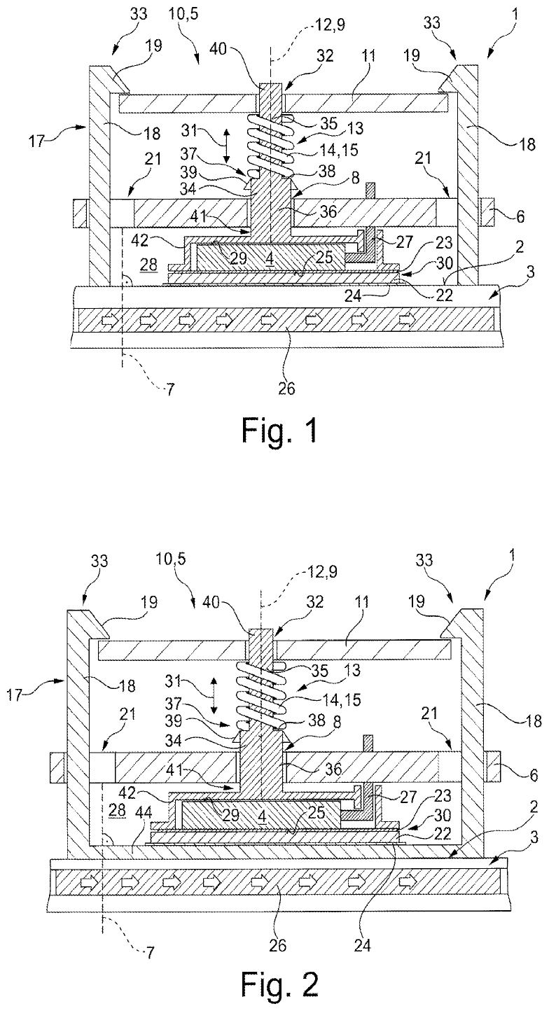

FIGS. 1 through 9 show embodiments of an induction charging unit, designated as a whole by the reference number 1, which, in an energy transmission system not illustrated, interacts or can interact with a counter-induction charging unit of the energy transmission system by means of a magnetic coupling in order to transfer energy without contact. The induction charging unit 1 is arranged in or on the ground on which the said battery-electric vehicle is parked, while the counter-induction charging unit is installed on a vehicle floor of the battery-electric vehicle. However, it is conceivable that the induction charging unit 1 described forms a counter-induction charging unit on the vehicle side, or that both the induction charging unit 1 and the counter-induction charging unit of the energy transmission system are equipped with the features of the induction charging unit 1 as described below.

FIGS. 1 through 9 each show an embodiment of the induction charging unit 1 for a power transmission system, which has a cooling device 3, at least one electrical power component 4, and a clamping device 5. The cooling device 3 is exemplarily realized by a cooling plate, through which a coolant flow 26 from coolant flows, as indicated by the arrows in FIG. 1 through 9. The coolant flow 26 can be used to dissipate heat energy from the cooling device 3, so that the latter can be regarded as a heat sink in simplified terms. The cooling device 3 forms a flat mounting face 2, wherein a vertical axis 7 indicated by a dashed line is perpendicular to it. The induction charging unit 1 also has an example of a flat printed circuit board 6, for example a PCB (Printed Circuit Board), which is located opposite the cooling device 3 in the direction of the vertical axis 7 and at the same time is aligned parallel to the assembly with respect to the mounting face 2, so that an installation space 28 for the at least one electrical power component 4 and possibly further components of the induction charging unit 1 is defined between the cooling device 3 and the printed circuit board 6. At least one electrical power component 4 is realized in the present case by a transistor, a diode, or a MOSFET, wherein it could also be realized by any other electrical component, at least in theory. At least one electrical power component 4 is positioned within the installation space 28 and is fixed to a printed circuit board body of the printed circuit board 6 by means of its electrical connection pins 27 and is connected in an electrically communicating manner to non-illustrated electrical conductor tracks of the printed circuit board 6 by means of the connection pins 27. The connection pins 27 can each be conveniently angled and inserted with a free leg through the unillustrated pin openings provided in the printed circuit board 6 for this purpose. At least one electrical power component 4 defines a flat component face 25, which in this case is aligned parallel to the mounting face 2 and is located opposite the latter in the direction of the vertical axis 7. Furthermore, at least one electrical power component 4 has a counter-component face 29, which is opposite to the component face 25 and runs parallel to the mounting face 2. Furthermore, the at least one electrical power component 4 also has side faces which are aligned transversely with respect to the component face 25, the counter-component face 29, and the mounting face 2, but are not provided with reference numbers in the present case. The component face 25 and the counter-component face 29 exemplarily form large surfaces, while the aforementioned side faces form narrow surfaces.

In the case of known induction charging units, the electrical power components are insufficiently thermally coupled to the cooling device of the induction charging unit, so that optimal cooling cannot be achieved. In order to overcome this disadvantage, it is essential that the at least one electrical power component 4 is clamped by means of the said clamping device 5 of the induction charging unit 1 onto the mounting face 2 of the cooling device 3 in the direction of the vertical axis 7 or, if necessary, at a slight angle with respect to the same. As a result, the at least one electrical power component 4 is clamped or pressed onto the cooling device 3 in a manner that is particularly free of gaps, so that an excellent thermal coupling of the at least one electrical power component 4 with the cooling device 3 is realized. This has the advantage that a relatively large flow of thermal energy can be transferred from the at least one electrical power component 4 to the cooling device 3 and dissipated by the same, whereby the at least one electrical power component 4 is excellently cooled or can be cooled.

The clamping device 5 in question can be implemented by means of various design measures, wherein seven such design measures are proposed in FIGS. 1 through 9.

According to FIG. 1, the clamping device 5 is realized by a spring clamp device 10, which clamps the at least one electrical power component 4 in the direction of the vertical axis 7 to the cooling device 3 in a spring-elastic manner, i.e., at right angles to the mounting face 2, whereby the component face 25 of the at least one electrical power component 4 is mechanically and thermally coupled to the mounting face 2 and the at least one electrical power component 4 is mechanically and thermally coupled to the cooling device 3. The coupling can be realized in such a way that the at least one electrical power component 4 is clamped with its component face 25 in direct contact with the mounting face 2, which is not illustrated in the present case, or that the at least one electrical power component 4 is clamped with its component face 25 indirectly to the mounting face 2, namely with a layer arrangement 30 of individual layers 22, 23, 24 interposed therebetween. According to FIG. 1, it can be seen that a first individual layer of the layer arrangement 30 is provided, hereinafter referred to as coupling layer 22. The coupling layer 22 is arranged in the direction of the vertical axis 7 between the mounting face 2 of the cooling device 3 and the component face 25 of the at least one electrical power component 4, wherein it is sandwiched between the mounting face 2 and the component face 25. The coupling layer 22 is non-releasably fixed over its entire surface to the component face 25 by means of a second individual layer of the layer arrangement 30, which is designated as a fixing layer 23 and will be described in more detail below, or, for example, by soldering with a suitable solder material or by soldering by means of a solder coating applied to the coupling layer 22. The coupling layer 22 can be made of a ceramic material, wherein it has a material thickness in the range of 0.2 mm to 2 mm in the direction of the vertical axis 7 and/or a thermal conductivity, for example perpendicular to the material thickness, in the range of 0.2 W/mK to 50 W/mK and/or an electrical breakdown strength in the range of greater than or equal to 500 V DC. Alternatively, the coupling layer 22 can be made of a composite material, for example a plastic-based heat conducting film or a plastic-based heat conducting pad or a graphite film with an electrical insulating layer made of plastic. In this case, it has a material thickness in the range of 0.05 mm to 1 mm in the direction of the vertical axis 7 and/or a thermal conductivity, for example perpendicular to the material thickness, in the range of 0.1 W/mK to 5 W/mK and/or an electrical breakdown strength in the range of greater than or equal to 200 V DC. On the basis of the coupling layer 22, at least one electrical power component 4 can be optimally coupled mechanically and thermally to the cooling device 3.

With regard to the aforementioned fixing layer 23, it should be explained that it is arranged in the direction of the vertical axis 7 between the aforementioned coupling layer 22 and the component face 25 of the at least one electrical power component 4 and is designed to permanently and non-detachably connect the coupling layer 22 to the at least one electrical power component 4. In particular, the fixing layer 23 can be sandwiched between the coupling layer 22 and the component face 25. The fixing layer 23 is thin in relation to the coupling layer 22, viewed in the direction of the vertical axis 7, and is realized, for example, as an adhesive layer that is made of a thermally conductive adhesive material, wherein it has a material thickness in the range of 5 μm to 150 μm and/or a thermal conductivity in the range of 0.2 W/mK to 50 W/mK in the direction of the vertical axis 7. In particular, the fixing layer 23 can be used to achieve an optimal thermal and/or mechanical coupling of the coupling layer 22 with the at least one electrical power component 4.

FIG. 1 also shows that layer arrangement 30 has a third individual layer 22, 23, 24, referred to below as contact layer 24. The contact layer 24 is arranged in the direction of the vertical axis 7 between the coupling layer 22 and the mounting face 2 of the cooling device 3 and is designed to contact the coupling layer 22 with the cooling device 3. The contact layer 24 is sandwiched between the coupling layer 22 and the mounting face 2 and is realized, for example, by a relatively thin oil film of thermal grease. In particular, the contact layer 24 is designed to be non-adhesive and non-hardening, whereby the coupling layer 22 and the at least one electrical power component 4 are not permanently connected to the mounting face 2 or the cooling device 3, but can be uninstalled. The contact layer 24 enables an optimal thermal and/or mechanical coupling of the coupling layer 22 with the cooling device 3 and, as mentioned, a relatively simple deinstallation of the at least one electrical power component 4 from the cooling device 3.

The above-mentioned spring clamp device 10 according to FIG. 1 has a base body 11 which is immovable with respect to the cooling device 3, which can be realized by a flat plate or a housing cover and is arranged on a side of the printed circuit board 6 facing away from the cooling device 3, a holding device 17 consisting of tie rods 18 fixed to the cooling device 3 and projecting away from the cooling device 3 in the direction of the vertical axis 7 in the manner of fingers, by means of which the base body 11 is releasably fixed to the cooling device 3. By way of example only, the tie rods 18 are fixed to the cooling device 3 by soldering and the printed circuit board 6 passes through tie rod openings 21 arranged for this purpose on the printed circuit board 6, and at its free ends 33 has opposing form-fitting contours for clipping on the base body 11, which, by way of example, is a pair of latching lugs 19. For example, the base body 11 can be inserted in the direction of the vertical axis 7 between the two tie rods 18, wherein the base body 11 then initially slides over the latching lug bevels of the latching lugs 19, wherein the tie rods 18 are elastically deflected transversely to the vertical axis 7 until the base body 11 has passed the latching lug bevels of the latching lugs 19, wherein the tie rods 18 then elastically spring back into their initial position and bear against the base body 11.

The spring clamp device 10 also has a clamping element 13 defining a clamping element center axis 12 in its main direction of expansion, which is mounted on the base body 11 so as to be longitudinally adjustable in the direction of the clamping element center axis 12 on a bearing mount 32 of the base body 11, for example a plain bearing mount realized by a simple opening in the base body 11, and can perform an adjusting movement 31 indicated by a double arrow in FIG. 1. The clamping element 13 or its clamping element center axis 12 is perpendicular to the base body 11. Furthermore, the spring clamp device 10 is arranged on the cooling device 3 in such a way that the vertical axis 7 and the clamping element center axis 12 are parallel to each other. The clamping element 13 has a round shaft 34 that extends in the direction of the clamping element center axis 12 and divides into a first shaft section 35 with a first diameter and a second shaft section 36 with a second diameter, which is integrally connected to the first shaft section 35. As an example, the first diameter is smaller than the second diameter, whereby a bearing shoulder 38 for an adjusting spring 14, which will be described below, is formed at a transition region 37 between the first shaft section 35 and the second shaft section 36. In the transition region 37, there are also shaft latching lugs 39 with a lug bevel, which are arranged on the second shaft section 36 and distributed evenly around the circumference of the same. Furthermore, the first shaft section 35 forms a bearing section 40 that interacts with the bearing mount 32 of the base body 11 at its free shaft section end facing away from the transition region 37. The second shaft section 36 of the clamping element 13 engages, like the tie rods 18, through an opening 8 in the printed circuit board 6, which passes completely through the printed circuit board 6 in the direction of the vertical axis 7 and is aligned with the bearing mount 32, so that the second shaft section 36 or the clamping element projects into the installation space 28. The opening 8 and the at least one electrical power component 4 are exemplary on an alignment line 9, which is parallel with respect to the vertical axis 7 and is identical in this case with the clamping element center axis 12. At its free shaft section end 41, which is turned away from the transition region 37 and arranged within the installation space 28, the second shaft section 36 has an integral, plate-like holder 42 for holding the at least one electrical power component 4. By way of example, the holder 42 encloses the at least one electrical power component 4 at least in sections. For example, the counter-component face 29 of at least one electrical power component 4 encloses at least one of the said side faces of the at least one electrical power component 4. In particular, it is envisaged that the holder 42 is connected to the at least one electrical power component 4, for example by using an adhesive or by realizing a form-fitting connection with clips or the like. In particular, this can ensure that the clamping element 13 electrically insulates the at least one electrical power component 4 from the printed circuit board 6, for example to achieve an electrical breakdown strength in the range of greater than or equal to 200 V DC.

The spring clamp device 10 also has an adjusting spring 14 arranged on the round shaft 34 of the clamping element 13, which in this case is implemented by a spiral pressure spring 15, which is supported axially on the one hand on the supporting shoulder 38 of the clamping element 13 and on the other hand on the base body 11 in the region of the bearing mount 32. In this case, the spiral pressure spring 15 clamps the clamping element 13 axially with respect to the clamping element center axis 12 onto the at least one electrical power component 4, so that it is clamped by means of the clamping element 13 onto the mounting face 2 of the cooling device 3. Furthermore, the spiral pressure spring 15 simultaneously tensions the base body 11 axially with respect to the clamping element center axis 12 onto the tie rods 18, so that the base body 11 is immovably fixed to the tie rods 18. The spring force of the spiral pressure spring 15 can be adjusted according to a preferred contact pressure to be achieved by the at least one electrical power component 4 on the mounting face 2. The said components of the spring clamp device 10 are relatively inexpensive and, for example, available in large quantities in stores, so that an induction charging unit 1 equipped with the said spring clamp device 10 can be manufactured relatively inexpensively.

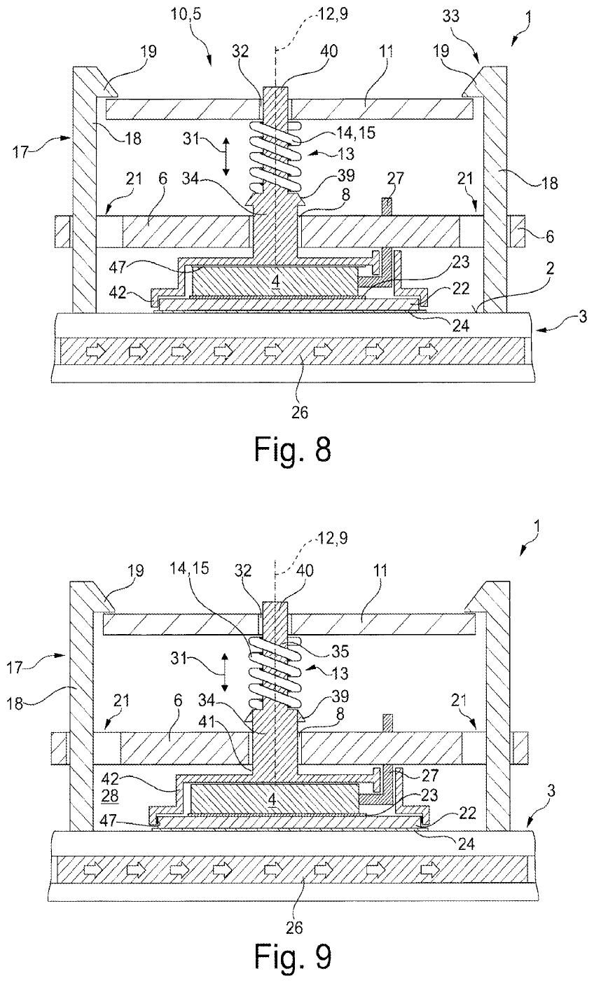

As an example, it can also be envisaged that the at least one electrical power component 4 is connected to the said coupling layer 22, i.e., in particular is in thermal and/or mechanical contact with it. The coupling layer 22 is advantageously connected in a material-fitting manner to at least one electrical power component 4. At the same time, the holder 42 and the clamping element 13, together with the coupling layer 22, can form an electrical insulation, in particular an all-round sealed electrical insulation, for the at least one electrical power component 4, in the manner of an encapsulation or a housing. The electrical insulation mentioned can be realized exemplarily in that the holder 42 and/or the clamping element 13 engage over an edge of the coupling layer 22 and/or embrace the same. FIGS. 8 and 9 show possible variants for the clamping device 5 from FIG. 1, wherein, to achieve the said electrical insulation, the at least one electrical power component 4 is glued to the holder 42 or sealed with respect to the same using a suitable means. Adhesive layers are marked with reference number 47 in each case. A form-fitting connection is also possible. Furthermore, it may be provided that an assembly formed from the holder 42, the clamping element 13, at least one electrical power component 4, and the coupling layer 22 is tested with regard to the effectiveness of the realized electrical insulation before final installation on a printed circuit board 6 or a cooling device 3. This confirms the electrical insulation effect and thus protects the sensitive components of this assembly. Furthermore, the quality of the heat-conducting fixing layer 23 could also be tested before final installation.

FIG. 2 shows a further embodiment for an induction charging unit 1 for an energy transfer system. In contrast to the embodiment according to FIG. 1, it is envisaged that the tie rods 18 are connected to a reinforcing component 44, which is placed flat on the mounting face 2 of the cooling device 3 and is soldered to the same, for example. This allows the cooling device 3 to be specifically reinforced, for example stiffened, at the point where the at least one electrical power component 4 is clamped to the cooling device 3 by means of the clamping device 5.

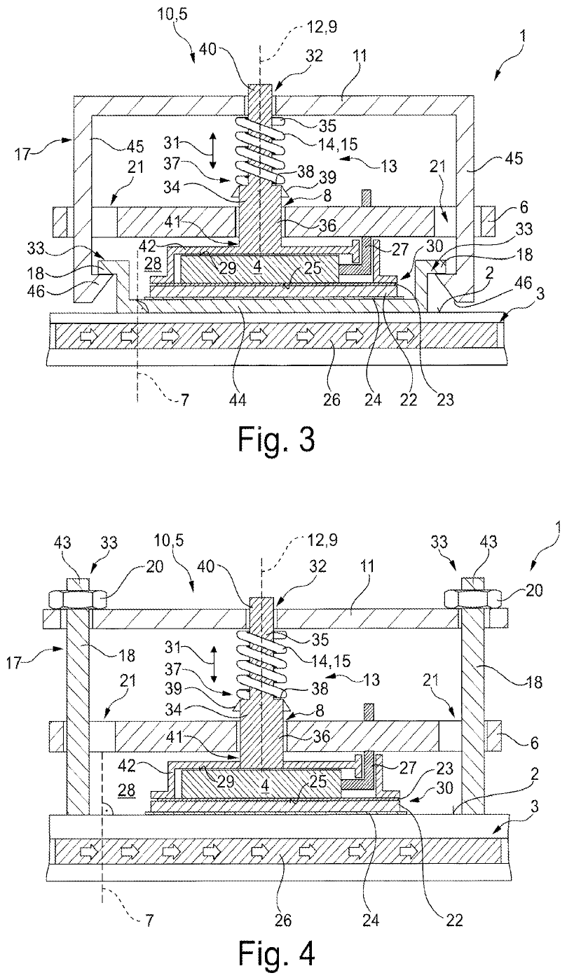

FIG. 3 shows a further embodiment for an induction charging unit 1 for an energy transfer system. In contrast to the embodiment according to FIG. 1, it is envisaged that the base body 11 is equipped with integral hook arms 45 with hook-arm latching lugs 46, which can be clipped onto the tie rods 18. This allows the tie rods 18 to be designed to be relatively compact. In addition, it is envisaged here, analogous to the embodiment illustrated in FIG. 2, that the tie rods 18 are connected to a reinforcing component 44, which is placed flat on the mounting face 2 of the cooling device 3 and is soldered to the same, for example. This allows the cooling device 3 to be specifically reinforced, for example stiffened, at the point where the at least one electrical power component 4 is clamped to the cooling device 3 by means of the clamping device 5.

FIG. 4 shows a further embodiment for an induction charging unit 1 for an energy transfer system. In contrast to the embodiment according to FIG. 1, it is envisaged that the tie rods 18 are not equipped with latching lugs 19, but instead form fastening screws 43, wherein the base body 11 is placed on the tie rods 18 and secured to the same with fastening nuts 20.

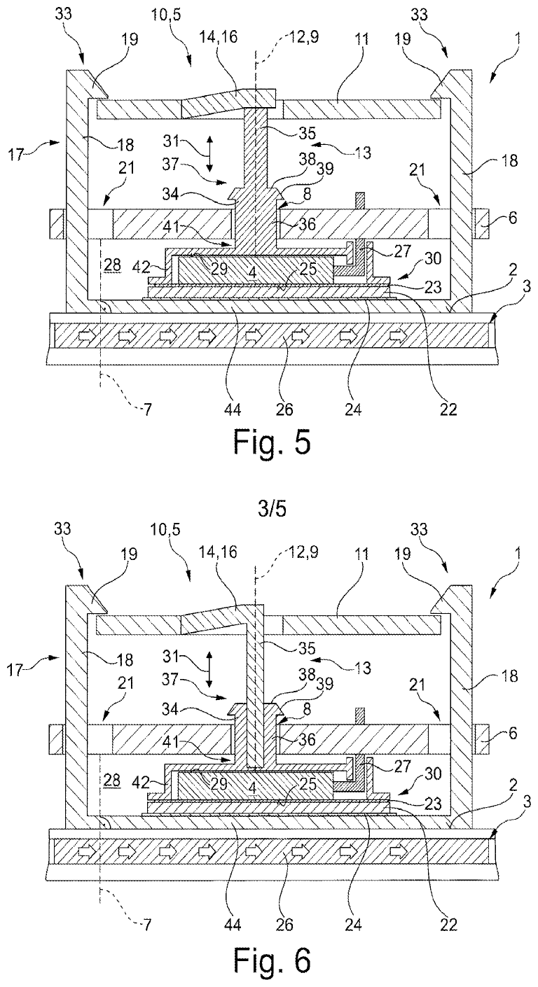

FIG. 5 shows a further embodiment for an induction charging unit 1 for an energy transfer system. In contrast to the embodiment according to FIG. 1, it is envisaged that the adjusting spring 14 is now implemented by a leaf spring 16 that is integral with the base body 11, instead of a pressure spring 15. As a result, the adjusting spring 14 is designed integrally with the base body 11, simplifying installation and eliminating the need for a component. In addition, it is envisaged here, analogous to the embodiment illustrated in FIG. 2, that the tie rods 18 are connected to a reinforcing component 44, which is placed flat on the mounting face 2 of the cooling device 3 and is soldered to the same, for example. This allows the cooling device 3 to be specifically reinforced, for example stiffened, at the point where the at least one electrical power component 4 is clamped to the cooling device 3 by means of the clamping device 5.

FIG. 6 shows a further embodiment for an induction charging unit 1 for an energy transfer system. In contrast to the embodiment according to FIG. 1, it is envisaged that the adjusting spring 14 is now implemented by a leaf spring 16 that is integral with the base body 11, instead of a pressure spring 15. As a result, the adjusting spring 14 is designed integrally with the base body 11, simplifying installation and eliminating the need for a component. In contrast to the embodiment illustrated in FIG. 5, the leaf spring 16 also forms a section of the clamping element 13, namely the first shaft section 35, which is expedient. As in the embodiment illustrated in FIG. 2, it is also envisaged here that the tie rods 18 are connected to a reinforcing component 44, which is placed flat on the mounting face 2 of the cooling device 3 and is soldered to the same, for example. This allows the cooling device 3 to be specifically reinforced, for example stiffened, at the point where the at least one electrical power component 4 is clamped to the cooling device 3 by means of the clamping device 5.

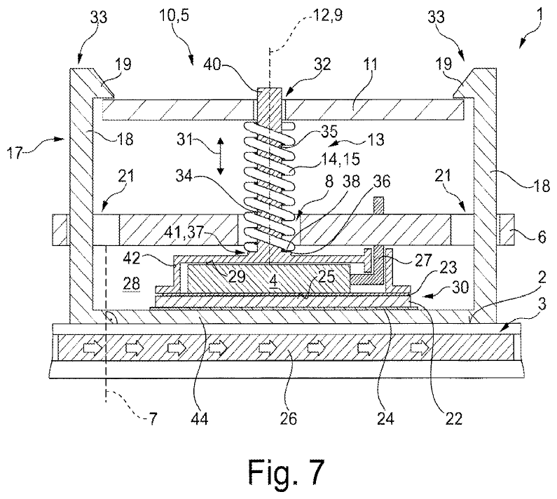

FIG. 7 shows a further embodiment for an induction charging unit 1 for an energy transfer system. In contrast to the embodiment according to FIG. 1, it is envisaged that the second shaft section 36 of the clamping element 13 is axially short or completely omitted in the direction of the clamping element center axis 12 in comparison to the first shaft section 35 of the clamping element 13. As in the embodiment illustrated in FIG. 2, it is also envisaged here that the tie rods 18 are connected to a reinforcing component 44, which is placed flat on the mounting face 2 of the cooling device 3 and is soldered to the same, for example. This allows the cooling device 3 to be specifically reinforced, for example stiffened, at the point where the at least one electrical power component 4 is clamped to the cooling device 3 by means of the clamping device 5.

1. An induction charging unit for an energy transfer system, comprising:
a cooling device defining a mounting face and configured to dissipate heat energy;
at least one electrical power component; and
a clamping device;
wherein the at least one electrical power component is clamped to the mounting face of the cooling device via the clamping device.

2. The induction charging unit according to claim 1, further comprising a printed circuit board, wherein:
the printed circuit board is disposed opposite the cooling device in a direction of a vertical axis perpendicular to the mounting face;
the at least one electrical power component is disposed in the direction of the vertical axis between the printed circuit board and the cooling device, and is arranged on the printed circuit board; and
at least one of:
the clamping device engages through an opening of the printed circuit board; and
the clamping device is arranged on a side of the printed circuit board facing away from the cooling device.

3. The induction charging unit according to claim 2, wherein at least one of:
the opening completely penetrates the printed circuit board in the direction of the vertical axis; and
the opening and the at least one electrical power component are disposed on an alignment line.

4. The induction charging unit according to claim 1, wherein the clamping device includes at least one of i) at least one spring clamp and ii) at least one spring clamp device.

5. The induction charging unit according to claim 4, wherein:
the clamping device includes the at least one spring clamp device; and
the at least one spring clamp device includes:
a base body that is immobile with respect to the cooling device;
a clamping element that defines a clamping element center axis in a main direction of expansion of the clamping element; and
an adjusting spring arranged on the clamping element.

6. The induction charging unit according to claim 5, wherein at least one of:
the adjusting spring tensions the clamping element axially with respect to the clamping element center axis onto the at least one electrical power component such that the at least one electrical power component is clamped onto the mounting face of the cooling device via the clamping element;
the adjusting spring is arranged on a side of the printed circuit board facing away from the cooling device;
the clamping element is mounted on the base body such that the clamping element is adjustable longitudinally in a direction of the clamping element center axis;
the clamping element center axis extends parallel to a vertical axis perpendicular to the mounting face; and
the clamping element engages through an opening in a printed circuit board.

7. The induction charging unit according to claim 5, wherein the adjusting spring is one of:
a pressure spring that is supported on the base body and the clamping element, and that is guided on the clamping element; and
a leaf spring that is integrally formed with the base body.

8. The induction charging unit according to claim 5, wherein the clamping element is connected to the at least one electrical power component.

9. The induction charging unit according to claim 5, wherein:
the at least one spring clamp device further includes a holding device defined by a plurality of tie rods fixed to the cooling device, the base body connectable to the cooling device in at least one of a releasable, a form-fitting, and a force-fitting manner via the plurality of tie rods; and
at least one of:
the plurality of tie rods include a plurality of form-fitting contours via which the base body is releasably fixable to a respective tie rod of the plurality of tie rods in at least one of a form-fitting and a force-fitting manner;
the base body is fixable to a respective tie rod of the plurality of tie rods in at least one of a releasable, a form-fitting, and a force-fitting manner via a plurality of fastening elements;
the plurality of tie rods are fixed to the cooling device in a material-fitting manner; and
the plurality of tie rods at least one of pass through and engage around an outer edge of a printed circuit board.

10. The induction charging unit according to claim 1, further comprising a coupling layer arranged in a direction of a vertical axis perpendicular to the mounting face of the cooling device between the mounting face and a flat component face defined by the at least one electrical power component, wherein at least one of:
the coupling layer is contacted with the at least one electrical power component;
the coupling layer is in contact with the cooling device;
the coupling layer is fixed to the component face of the at least one electrical power component;
the coupling layer is releasably clamped in contact with the mounting face;
the coupling layer is composed of a ceramic material;
the coupling layer has a material thickness in the direction of the vertical axis of 0.2 mm to 2 mm;
the coupling layer has a thermal conductivity of 0.2 W/mK to 50 W/mK;
the coupling layer has an electrical breakdown strength of at least 500 V DC; and
the coupling layer is composed of a composite material and has at least one of a material thickness of 0.05 mm to 1 mm in the direction of the vertical axis, a thermal conductivity of 0.1 W/mK to 5 W/mK, and an electrical breakdown strength of at least 200 V DC.

11. The induction charging unit according to claim 10, further comprising a fixing layer arranged in the direction of the vertical axis between and connecting the coupling layer and the component face of the at least one electrical power component, wherein at least one of:
the fixing layer is thin in the direction of the vertical axis with respect to the coupling layer;
the fixing layer is composed of a thermally conductive adhesive material;
the fixing layer has a material thickness of 5 μm to 150 μm in the direction of the vertical axis; and
the fixing layer has a thermal conductivity of 0.2 W/mK to 50 W/mK.

12. The induction charging unit according to claim 5, wherein the clamping element is connected to the at least one electrical power component in at least one of a form-fitting, a force-fitting, and a material-fitting manner.

13. The induction charging unit according to claim 5, wherein the clamping element electrically insulates the at least one electrical power component with respect to the cooler device.

14. The induction charging unit according to claim 10, further comprising a contact layer arranged in the direction of the vertical axis between the coupling layer and the mounting face of the cooling device, the contact layer configured to make contact between the coupling layer and the cooling device, wherein at least one of:
the contact layer is a film of heat transfer oil;
the contact layer is non-adhesive; and
the contact layer is non-hardening.

15. An energy transmission system for inductively charging a battery-powered electric vehicle with electrical energy, comprising:
the induction charging unit according to claim 1; and
a counter-induction charging unit arranged on the vehicle;
wherein the induction charging unit and the counter-induction charging unit are configured to transfer energy in a contactless manner via magnetic coupling.

16. The induction charging unit according to claim 2, wherein the printed circuit board is arranged parallel to the mounting face.

17. The induction charging unit according to claim 2, wherein:
the opening extends completely through the printed circuit board in the direction of the vertical axis; and
the opening and the at least one electrical power component are disposed on an alignment line extending parallel to the vertical axis.

18. The induction charging unit according to claim 2, wherein the clamping device is a spring clamp device including:
a base body that is immobile with respect to the cooling device;
a clamping element having a main direction of expansion and electrically insulating the at least one electrical power component with respect to the printed circuit board and with respect to the cooler device; and
an adjusting spring arranged on the clamping element.

19. The induction charging unit according to claim 18, wherein the spring clamp device further includes a plurality of tie rods releasably connected to the base body and fixed to the cooling device via a welded connection.

20. The induction charging unit according to claim 8, wherein the clamping element is glued to the at least one electrical power component.
